(19) United States
(12) Patent Application Publication
(10) Pub. No.: US 2021/0142307 A1
(43) Pub. Date: May 13, 2021

(54) STORAGE DEVICE AND METHOD

(71) Applicant: TOSHIBA TEC KABUSHIKI KAISHA, Tokyo (JP)

(72) Inventor: Shota Konishi, Kawasaki Kanagawa (JP)

(21) Appl. No.: 16/911,679

(22) Filed: Jun. 25, 2020

(30) Foreign Application Priority Data
Nov. 12, 2019 (JP) 2019-205000

(51) Int. Cl. G06Q 20/20; G07F 11/40

(52) U.S. Cl. CPC G06Q 20/203; G07F 11/40

(57) ABSTRACT

According to one embodiment, a storage unit having a space for storing commodities therein and provided with a first opening accessible to space, a first door unit capable of opening and closing the first opening, a display unit provided on a surface of the first door unit, and a control unit configured to acquire an image corresponding to a commodity and displays the image on the display unit when the commodity is stored in the storage unit are included.

### CROSS-REFERENCE TO RELATED APPLICATION

This application is based upon and claims the benefit of priority from Japanese Patent Application No. 2019-205000, filed in Nov. 12, 2019, the entire contents of which are incorporated herein by reference.

### FIELD

Embodiments described herein relate generally to a storage device and a method.

### BACKGROUND

In a related art, in a facility such as a supermarket, a restaurant street called a food court is provided. In such a food court, a service in which a user orders a desired commodity at a store that manufactures and sells the commodity from a plurality of stores (restaurants), and then the user himself/herself carries the commodity and eats and drinks is provided.

On the other hand, in the related art, a system has been proposed in which commodities are handed over to a customer via a storage device including a plurality of lockers connected to a network.

Meanwhile, a form in which the hand-over of a commodity from a restaurant to a user is performed via the storage device by placing the above-mentioned storage device in a food court or the like is conceivable. However, the storage device of the related art is not considered to be used in a food court or the like at all and is difficult to apply. In addition, in the storage device of the related art, the user cannot visually confirm the information on the commodity stored in each locker. For this reason, in an environment such as a food court where a plurality of users wait for the reception of a commodity near the storage device, the storage status of the commodity cannot be easily checked, and there is a problem in terms of convenience.

### DESCRIPTION OF THE DRAWINGS

FIG. 1 is a diagram showing an example of a configuration of a locker system according to an embodiment;

FIGS. 2A and 2B are perspective views showing an example of an external configuration of a storage device according to the embodiment;

FIG. 3 is a diagram showing an example of a hardware configuration of a control device according to the embodiment;

FIG. 4 is a diagram showing an example of a hardware configuration of a server device according to the embodiment;

FIG. 5 is a diagram showing an example of a data configuration of a locker management table according to the embodiment;

FIG. 6 is a diagram showing an example of a data configuration of a store image management table according to the embodiment;

FIG. 7 is a diagram showing an example of a data configuration of a commodity image management table according to the embodiment;

FIG. 8 is a diagram showing an example of a functional configuration of the control device according to the embodiment;

FIG. 9 is a diagram showing an example of a functional configuration of the server device according to the embodiment;

FIG. 10 is a diagram showing an example of an image displayed on the storage device according to the embodiment;

FIG. 11 is a diagram showing an example of a screen displayed on the storage device of the embodiment;

FIG. 12 is a diagram showing an example of an image displayed on the storage device according to the embodiment;

FIG. 13 is a diagram showing an example of an image displayed on the storage device of the embodiment;

FIG. 14 is a diagram showing an example of an image displayed on the storage device of the embodiment;

FIG. 15 is a sequence diagram showing an example of processing performed by the store server, the user terminal, and the server device according to the embodiment;

FIG. 16 is a sequence diagram showing an example of processing performed by the control device and the server device according to the embodiment;

FIG. 17 is a flowchart showing an example of display image determination processing performed by the server device of the embodiment; and

FIG. 18 is a sequence diagram showing an example of processing performed by the control device and the server device according to the embodiment.

### DETAILED DESCRIPTION

An aspect of the present disclosure is to provide a storage device and a method that can present information on stored commodities.

In general, according to one embodiment, the storage device includes a storage unit, a first door unit, a display unit, and a control unit. The storage unit has a space for storing a commodity therein, and includes a first opening accessible to the space. The first door unit is capable of opening and closing the first opening. The display unit is provided on a surface of the first door unit. When a commodity is stored in the storage unit, the control unit acquires an image corresponding to the commodity and displays the image on the display unit.

Hereinafter, a storage device and a method according to an embodiment will be described with reference to the drawings. In an embodiment described below, in a food court provided in a facility such as a supermarket, a storage device for temporarily storing commodities (food (cuisine), beverage such as drinks) ordered by a user (customer) will be described as an example. In addition, the present disclosure is not limited to the embodiment described below.

FIG. 1 is a diagram showing an example of a configuration of a locker system according to the present embodiment. As shown in FIG. 1, the locker system 1 includes a storage device 10, a store server 20, a user terminal 30, and a server device 40. The storage device 10, the store server 20, the user terminal 30, and the server device 40 are communicably connected via a network N1 such as a local area network (LAN) or a public line provided in the facility.

The storage device 10 is installed at a predetermined position in a food court, near a food court doorway, or the like. The storage device 10 is used for the hand-over of commodity (food) between each store (restaurant) operating in the food court and a user who uses the store. Specifically, the store stores the commodity (food) ordered by the user in the storage device 10, thereby delivering the commodity. Further, the user receives the commodity (food) ordered in the store via the storage device 10.

FIGS. 2A and 2B are perspective views showing an example of an external configuration of the storage device 10. Here, FIG. 2A is a perspective view of the storage device 10 as viewed from the front side. FIG. 2B is a perspective view of the storage device 10 as viewed from the back side. In the present embodiment, the side facing the user using the food court is defined as the front.

As shown in FIGS. 2A and 2B, the storage device 10 includes a pedestal unit 11, a locker 12, and a control device 13. The pedestal unit 11 holds a locker 12 that is an example of a storage unit from below. Specifically, the pedestal unit 11 is a rectangular structure corresponding to the shape and the arrangement layout of the lockers 12, and has a predetermined height from the ground. Thereby, in the storage device 10, the locker 12 can be separated from the ground.

The locker 12 is formed of a substantially box-shaped housing, and has a space for storing commodities therein. One or a plurality of lockers 12 are prepared and arranged side by side or stacked on the upper part of the pedestal unit 11. In FIGS. 2A and 2B, four lockers 12 are arranged in the horizontal direction, and three lockers 12 are stacked in the height direction, so that a total of 15 lockers 12 are configured. The number and arrangement layout of the lockers 12 are not limited to the example of FIGS. 2A and 2B.

Each of the lockers 12 is assigned with a locker ID, which is a unique identifier. The locker ID is, for example, a locker number. The control device 13 and the server device 40 described later can manage the locker 12 based on the locker ID.

The locker 12 includes an opening 12a on the front side. The locker 12 includes a door unit 121 that can open and close the opening 12a. Here, the opening 12a corresponds to a first opening. Further, the door unit 121 corresponds to a first door unit.

A display unit 122 which is a flat display such as a liquid crystal display (LCD) is provided on the surface of the door unit 121. FIGS. 2A and 2B show examples in which the display unit 122 is provided on the entire surface of the door unit 121, but the area of the display unit 122 occupying the surface of the door unit 121 is not limited thereto.

The locker 12 also includes an opening 12b on the back side. The locker 12 includes a door unit 123 that can open and close the opening 12b on the back side. Here, the opening 12b corresponds to a second opening. The door unit 123 corresponds to a second door unit.

The door unit 123 is provided with a handle 124. The opening 12a and the opening 12b are both connected to the inside of the locker 12, and the inside of the locker 12 can be accessed through these openings 12a and 12b.

In the present embodiment, the opening 12b (door unit 123) provided on the back side of the locker 12 is used when a commodity is stored (delivered) in the locker 12. On the other hand, the opening 12a (door unit 121) provided on the front side of the locker 12 is used when taking out a commodity from the locker 12. That is, the storage device 10 is configured such that different doors are used for storing and taking out the commodity.

Each of the lockers 12 is provided with an electronic lock mechanism for individually locking the door unit 121 and the door unit 123. Further, each of the lockers 12 is provided with a detection mechanism for individually detecting the open or closed state of the door unit 121 and the door unit 123. Such a detection mechanism is used for detecting the operation of storing (delivering) a commodity in the locker 12 and the operation of taking out (receiving) the commodity from the locker 12. Further, instead of the above-described detection mechanism, a weight sensor or the like may be provided on the bottom surface of the locker 12. The electronic lock mechanism and the detection mechanism are connected to the control device 13 described later.

The configuration of the locker 12 is not limited to the examples of FIGS. 2A, 2B and 3. For example, in FIGS. 2A and 2B, the handle 124 is provided on the door unit 123 on the back side, but the door unit 121 on the front side may also be provided with an opening and closing support member such as the handle 124 or a dent for opening and closing support.

The control device 13 is an example of a control device that controls the operation of the storage device 10 (locker 12) under the control of the server device 40. The control device 13 includes, for example, a rectangular column-shaped housing 13a and is provided near the pedestal unit 11 and the locker 12. In the present embodiment, the control device 13 is provided separately from the pedestal unit 11 and the locker 12, but is not limited thereto, and may be provided in the arrangement of the lockers 12.

A short-range communication unit 131 capable of performing short-range wireless communication such as near field communication (NFC) is provided on the front side of the housing 13a. A display unit 132 and an input unit 133 are provided on the back side of the housing 13a. The display unit 132 is a display such as an LCD, and displays information input through the input unit 133 and various information related to the operation of the storage device 10. The input unit 133 is an input device such as an operation button or a keyboard.

The short-range communication unit 131 and the input unit 133 described above function as an input interface when a user or a clerk inputs information to the storage device 10. For example, a store clerk inputs the locker ID specified by the server device 40 described later together with the store ID for identifying the store, a preset password, and the like to the input unit 133 when storing a commodity in the locker 12. In addition, the user performs an operation of holding the user terminal 30 owned by the user over the short-range communication unit 131 to input the terminal ID of the user terminal 30 via the short-range communication unit 131. Here, the terminal ID is an identifier for identifying the user terminal 30, and for example, address information (telephone number, IP address, or the like) unique to the user terminal 30, a manufacturing ID, or the like can be used.

In the configuration of FIGS. 2A, 2B and 3, only the short-range communication unit 131 is provided on the front side of the housing 13a, but the display unit 132 and the input unit 133 may be provided similarly to the back side. Further, the short-range communication unit 131 may be provided on the back side of the housing 13a.

The control device 13 has a hardware configuration shown in FIG. 3 inside the housing 13a. FIG. 3 is a diagram showing an example of the hardware configuration of the control device 13.

As shown in FIG. 3, the control device 13 includes a central processing unit (CPU) 134, a read only memory (ROM) 135, and a random access memory (RAM) 136, and the like in addition to the above-described short-range communication unit 131, display unit 132, and input unit 133.

The CPU 134 is an example of a processor and controls each unit of the control device 13 in an integrated manner. The ROM 135 stores various programs. The RAM 136 is a workspace for loading programs and various data. The CPU 134 executes various processes by operating according to a program stored in the ROM 135 and a storage unit 137 described later and loaded in the RAM 136.

In addition, the control device 13 includes the storage unit 137, a communication unit 138, an interface 139, and the like. The storage unit 137 is configured by a hard disc drive (HDD), a flash memory, or the like, and maintains the stored contents even when the power is turned off. The storage unit 137 stores a program that can be executed by the CPU 134, setting information in which a locker ID of each locker 12 is set, and the like.

The communication unit 138 is a communication interface that can be connected to the network N1. The communication unit 138 communicates with external devices such as the user terminal 30 and the server device 40 via the network N1.

The interface 139 is connected to each of the lockers 12. Specifically, the electronic lock mechanism, the detection mechanism, and the like of each of the lockers 12 are electrically connected to the interface 139.

Returning to FIG. 1, the store server 20 is a server device provided at each store such as a restaurant operating at a food court. The store server 20 includes a display device, an input device, an auxiliary storage device, and the like, in addition to the computer configuration of the CPU, the ROM, and the RAM.

The store server 20 executes various processes related to store management. For example, when the store server 20 receives a commodity order from a user, the store server 20 executes a process for acquiring a locker ID serving as a storage destination (delivery destination) of the commodity from the server device 40.

Specifically, the store server 20 receives order information transmitted from the user terminal 30 via the network N1. Such order information includes at least a commodity ID for identifying the type of the commodity and a terminal ID for identifying the user terminal 30 of the transmission source.

Upon receiving the order information, the store server 20 transmits the order information, the terminal ID of the user terminal 30 that transmitted the order information, and the store ID for identifying its own store to the server device 40. As a result, the server device 40 returns (instructs) a locker ID, which is the storage destination of the commodity to the store server 20 by the processing described later. In the store of the store server 20, when the manufacturing (cooking or the like) of the ordered commodity is completed, the clerk carries the commodity to the storage device 10. Then, the clerk inputs the specified locker ID or the like via the input unit 133 to unlock the door unit 123 of the corresponding locker 12 and stores the commodity inside the locker 12 through the opening 12b.

The user terminal 30 is a terminal device carried by a user who uses the food court. The user terminal 30 may be a terminal device such as a smartphone owned by the user in advance, or may be a dedicated terminal device (order terminal or the like) lent to a user who uses the food court.

The user terminal 30 includes a display device such as an LCD, an input device such as a touch panel, an auxiliary storage device, and the like, in addition to the computer configuration of the CPU, the ROM, and the RAM. Further, the user terminal 30 includes a communication device capable of wirelessly connecting to the network N1, and a short-range communication device capable of performing short-range wireless communication with the short-range communication unit 131.

The user terminal 30 executes various processes related to a commodity order. For example, the user terminal 30 displays an order screen on which each commodity sold by each store can be ordered in response to an operation of the user. When the user terminal 30 accepts the operation of determining the commodity to be ordered, the user terminal 30 transmits the order information including the commodity ID of the commodity together with the terminal ID of the own user terminal 30 to the store server 20 of the store that manufactures and sells the commodity to be ordered. Further, the user terminal performs short-range wireless communication with the short-range communication unit 131 and transmits the terminal ID of the user terminal 30 to the short-range communication unit 131.

The server device 40 is communicably connected to external devices such as the storage device 10 and the store server 20 via the network N1.

The server device 40 manages the use status of each locker 12 in cooperation with the control device 13 of the storage device 10.

In addition, the server device 40 notifies the locker ID of the locker 12 used by each store to deliver a commodity in response to an inquiry from the store server 20. Specifically, when the order information, the store ID, and the terminal ID are transmitted from the store server 20, the server device 40 notifies the store server 20, which is the transmission source, of the locker ID of the locker 12, which is the storage destination of the commodity, based on the use status of each locker 12.

The server device 40 controls an image displayed on the display unit 122 of each locker 12 in cooperation with the control device 13 of the storage device 10.

FIG. 4 is a diagram showing an example of a hardware configuration of the server device 40. As shown in FIG. 4, the server device 40 has a computer configuration of a CPU 401, a ROM 402, a RAM 403, and the like.

The CPU 401 is an example of a processor and controls each unit of the server device 40 in an integrated manner. The ROM 402 stores various programs. The RAM 403 is a workspace for loading programs and various data. The CPU 401 executes various processes by operating according to programs stored in the ROM 402 and a storage unit 404 described later and loaded in the RAM 403.

Further, the server device 40 includes the storage unit 404, a communication unit 405, and the like. The storage unit 404 is configured by an HDD, a flash memory, or the like, and maintains the stored contents even when the power is turned off. The storage unit 404 stores programs that can be executed by the CPU 401 and various types of setting information. The storage unit 404 stores a locker management table T1, a store image management table T2, a commodity image management table T3, and the like.

The locker management table T1 is a data table for managing the use status of the storage device 10. FIG. 5 is a diagram showing an example of a data configuration of the locker management table T1. As shown in FIG. 5, the locker management table T1 stores items such as a store ID, a commodity ID, a terminal ID, and a delivery flag in association with the locker ID of each locker 12.

Here, the store ID transmitted with the order information is registered in the store ID. In the commodity ID, the commodity ID of the commodity to be ordered included in the order information is registered. The terminal ID transmitted with the order information is registered in the terminal ID.

The above-described store ID, commodity ID, and terminal ID are items registered based on the order information transmitted from the store server 20. That is, a locker ID in which the items of the store ID, the commodity ID, and the terminal ID are blank is an unused locker 12 (hereinafter, also referred to as an empty locker) that does not have a plan to store a commodity.

The delivery flag is flag information for determining whether or not the commodity is stored (delivered) in the locker 12. The delivery flag can be represented by, for example, a binary value of ON (1) and OFF (0). In the present embodiment, it is assumed that the delivery flag “OFF” indicates that the commodity is not stored, and the delivery flag “ON” indicates that the commodity is stored. It is assumed that the default value of the delivery flag is “OFF” indicating a non-delivery state.

The store image management table T2 is a data table for storing and managing image data related to each store. FIG. 6 is a diagram showing an example of a data configuration of the store image management table T2. As shown in FIG. 6, the store image management table T2 stores the store image of the store corresponding to the store ID in association with the store ID of each store.

Here, the store image is image data representing, for example, a store logo, a store name, an advertisement, and the like. The store image is not limited to still image data, and may be moving image data. Further, the number of store images stored in association with the same store ID is not limited to one, and a plurality of store images may be stored. For example, it is possible to store a plurality of store images having different screen sizes in association with the same store ID.

The commodity image management table T3 is a data table for storing and managing image data related to commodities manufactured and sold in each store. FIG. 7 is a diagram showing an example of a data configuration of the commodity image management table T3. As shown in FIG. 7, the commodity image management table T3 stores a commodity image of a commodity corresponding to the commodity ID in association with the commodity ID of each commodity.

Here, the commodity image is, for example, image data representing a photograph or illustration representing a commodity, a commodity name, an advertisement, or the like. The commodity image is not limited to still image data, and may be moving image data. Further, the number of commodity images stored in association with the same commodity ID is not limited to one, and a plurality of commodity images may be stored. For example, different types of commodity images or commodity images with different screen sizes may be stored in association with the same commodity ID.

Returning to FIG. 4, the communication unit 405 is a communication interface connectable to the network N1. The communication unit 405 communicates with external devices such as the storage device 10 (control device 13) and the store server 20 via the network N1.

Next, a functional configuration of the control device 13 and the server device 40 described above will be described.

First, a functional configuration of the control device 13 will be described with reference to FIG. 8. Here, FIG. 8 is a diagram showing an example of a functional configuration of the control device 13.

As shown in FIG. 8, the control device 13 includes a terminal ID acquisition unit 1301, an electronic lock control unit 1302, a delivery notification unit 1303, a reception notification unit 1304, and a display control unit 1305 as functional units.

Some or all of the functional units included in the control device 13 may have a software configuration realized by cooperation of the processor (CPU 134) of the control device 13 and various programs stored in the memory (the ROM 135, the storage unit 137, and the like). Further, some or all of the functional units included in the control device 13 may have a hardware configuration realized by a dedicated circuit or the like included in the device.

The terminal ID acquisition unit 1301 acquires the terminal ID of the user terminal 30 owned by the user as information for identifying the user who receives the commodity. Specifically, the terminal ID acquisition unit 1301 acquires, in cooperation with the short-range communication unit 131, the terminal ID from the user terminal 30 that established short-range communication with the short-range communication unit 131.

The electronic lock control unit 1302 controls locking and unlocking of the electronic lock mechanism provided in each of the lockers 12. Specifically, the electronic lock control unit 1302 controls the locking and unlocking of the electronic lock mechanism mounted on the door units 121 and 123 of the locker 12 in response to an instruction from the server device 40 or an operation via the input unit 133. It is assumed that the electronic lock control unit 1302 can individually control the electronic lock mechanisms of the door unit 121 and the door unit 123.

The delivery notification unit 1303 notifies the server device 40 of the locker ID of the locker 12 in which the commodity was stored (delivered). Here, the method of determining whether or not the commodity was stored is not particularly limited, and various methods can be adopted.

For example, the delivery notification unit 1303 may determine that the commodity was stored, based on the condition that the electronic lock mechanism of the door unit 123 is unlocked. In this case, the delivery notification unit 1303 notifies the server device 40 of the locker ID of the locker 12 in which the unlocking was performed. Further, for example, the delivery notification unit 1303 may determine that the commodity was stored, based on the condition that the opening and closing operation (change from the open state to the closed state) of the door unit 123 is detected by the detection mechanism of the locker 12. In this case, the delivery notification unit 1303 notifies the server device 40 of the locker ID of the locker 12 in which the opening and closing operation was performed. In addition, for example, if a weight sensor is provided at the bottom of the locker 12, the delivery notification unit 1303 may determine that the commodity was stored, based on the condition that the weight measured by the weight sensor changed (increased) to a threshold (for example, 10 grams) or more. In this case, the delivery notification unit 1303 notifies the server device 40 of the locker ID of the locker 12 whose weight increased.

The reception notification unit 1304 notifies the server device 40 of the locker ID of the locker 12 in which the commodity is received. Here, the method of determining whether or not the reception was performed is not particularly limited, and various methods can be adopted.

For example, the reception notification unit 1304 may determine that the commodity was received, based on the condition that the electronic lock mechanism of the door unit 121 is unlocked. In this case, the reception notification unit 1304 notifies the server device 40 of the locker ID of the locker 12 that was unlocked. Further, for example, the reception notification unit 1304 may determine that the commodity was received, based on the condition that the opening and closing operation of the door unit 121 (change from the open state to the closed state) is detected by the detection mechanism of the locker 12. In this case, the reception notification unit 1304 notifies the server device 40 of the locker ID of the locker 12 in which the opening and closing operation was performed. Further, for example, if a weight sensor is provided at the bottom of the locker 12, the reception notification unit 1304 may determine that the commodity was received, based on the condition that the weight measured by the weight sensor changed (decreased) below a threshold (for example, 10 grams). In this case, the reception notification unit 1304 notifies the server device 40 of the locker ID of the locker 12 whose weight was reduced.

The display control unit 1305 is an example of a control part and a control unit. The display control unit 1305 controls a screen displayed on the display unit 132 provided in each of the lockers 12 in cooperation with the server device 40 (a display control unit 4002 described below). Specifically, when a commodity is stored in the locker 12, the display control unit 1305 acquires an image corresponding to the commodity from the server device 40 and causes the display unit 122 of the locker 12 to display the acquired image. The image displayed by the locker 12 will be described later.

Next, a functional configuration of the server device 40 will be described with reference to FIG. 9. Here, FIG. 9 is a diagram showing an example of a functional configuration of the server device 40.

As shown in FIG. 9, the server device 40 includes a locker management unit 4001 and a display control unit 4002 as functional units.

Some or all of the functional units included in the server device 40 may have a software configuration realized by cooperation of the processor (CPU 401) of the server device 40 and various programs stored in the memory (the ROM 402, the storage unit 404, and the like). Further, some or all of the functional units included in the server device 40 may have a hardware configuration realized by a dedicated circuit or the like included in the device.

The locker management unit 4001 manages the use status of each locker 12 included in the storage device 10 based on the locker management table T1.

For example, when the order information, the terminal ID, and the store ID are transmitted from the store server 20, the locker management unit 4001 searches for a locker ID of an empty locker from the locker IDs registered in the locker management table T1. Next, the locker management unit 4001 registers the store ID, the terminal ID, and the commodity ID included in the order information, which are transmitted together with the order information, in association with the locker ID of the searched empty locker. Then, the locker management unit 4001 notifies the store server 20 of the locker ID in which various information such as the commodity ID is registered, as a storage destination (delivery destination) of the commodity corresponding to the commodity ID.

When there is no empty locker, the locker management unit 4001 may transmit information notifying the fact to the store server 20. The locker management unit 4001 may perform standby matrix processing until an empty locker is generated.

More specifically, the locker management unit 4001 temporarily stores the transmitted order information, terminal ID, and store ID in the RAM 403 or the like using a First In First Out (FIFO) method. When an empty locker is generated, the locker management unit 4001 reads out a set of order information, the terminal ID, and the store ID from the RAM 403, and registers the set in association with the locker ID of the empty locker. Thereby, the locker management unit 4001 can allocate an empty locker in the order in which the order information is transmitted.

When a plurality of empty lockers are found, the locker management unit 4001 may select any empty locker as a storage destination of a commodity, or may select one empty locker based on a predetermined rule. In the latter case, for example, the locker management unit 4001 may select an empty locker based on setting information (hereinafter, layout information) in which the locker ID of each locker 12 is associated with the arrangement position of the locker 12 in the storage device 10.

Specifically, the locker management unit 4001 specifies, based on the layout information, the arrangement position of the locker 12 corresponding to the locker ID in which the same store ID as the registration target store ID notified from the store server 20 is registered. Then, the locker management unit 4001 selects one empty locker from the locker IDs of the lockers 12 adjacent to the specified arrangement position of the locker 12. Here, the term “adjacent” is a concept that includes adjacent in the diagonal direction in addition to adjacent in the vertical and horizontal directions.

According to the above selection method, the locker management unit 4001 can collect the arrangement positions of the lockers 12 that are the storage destinations of the commodities manufactured and sold in the same store (store ID) in a group (hereinafter, also referred to as a cluster). Thereby, in the processing described later, the display unit 122 of the plurality of lockers 12 that are clustered can be used to efficiently display an enlarged display of a store image or the like.

Further, when the locker management unit 4001 is notified of the locker ID of the locker 12 to which the commodity was delivered, from the control device 13, the locker management unit 4001 sets the delivery flag associated with the locker ID to ON. Thereby, the locker management unit 4001 can determine whether or not the commodity was delivered, based on the value of the delivery flag associated with the locker ID.

The locker management unit 4001 may notify the user terminal 30 of the terminal ID associated with the corresponding locker ID that the delivery of the commodity was completed at the timing when the delivery flag is turned on. Thereby, the server device 40 can prompt the user of the user terminal 30 to receive the commodity, and thus, the turnover of the locker 12 and the turnover of each store can be improved.

When the terminal ID acquired by the terminal ID acquisition unit 1301 is notified from the control device 13, the locker management unit 4001 specifies the locker ID associated with the terminal ID from the locker management table T1. Then, the locker management unit 4001 transmits an instruction to unlock the electronic lock with the specified locker ID to the control device 13.

When the unlocking of the electronic lock is instructed from the server device 40, the electronic lock control unit 1302 of the control device 13 unlocks the electronic lock provided on the door unit 121 of the locker 12 corresponding to the specified locker ID. Thus, the user can take out (receive) the commodity through the opening 12a of the locker 12. In this manner, the storage device 10 keeps the door unit 121 locked until the terminal ID is read. Thus, in the storage device 10, it is possible to prevent the situation in which a third party other than the order user takes out the commodity from the locker 12.

When the delivery flag of the locker ID is turned off at the stage when the terminal ID is notified from the control device 13, it is preferred that the locker management unit 4001 suppress the unlock instruction because the commodity was not stored. Further, the locker management unit 4001 may cooperate with the display control unit 4002 to cause the control device 13 to transmit instruction information indicating that the commodity is not delivered (stored). In addition, the display control unit 1305 of the control device 13 may use the display unit 122 of the predetermined locker 12 (for example, the locker 12 adjacent to the control device 13) to display a message such as “currently in preparation” and to notify the user that the commodity was not delivered, in response to the instruction information.

When the locker management unit 4001 is notified of the locker ID of the locker 12 from which the commodity was received, from the control device 13, the locker management unit 4001 clears various information such as the commodity ID, the terminal ID, and the store ID associated with the locker ID from the locker management table T1. That is, the locker management unit 4001 switches the locker ID of the locker 12 for which the commodity was received to the empty locker state. The delivery flag is reset to “OFF”, which is a default value, when information is cleared.

The display control unit 4002 controls an image displayed on the display unit 122 of each locker 12 in cooperation with the control device 13 (display control unit 1305).

Specifically, when a commodity is stored in the locker 12, the display control unit 4002 acquires an image corresponding to the commodity from the store image management table T2 and the commodity image management table T3. Then, the display control unit 4002 provides the acquired image to the control device 13 to display an image corresponding to the commodity on the display unit 132 of the locker 12 in which the commodity is stored.

More specifically, the display control unit 4002 detects that the commodity was stored (delivered) by a notification from the control device 13 (reception notification unit 1304), or by switching the delivery flag to the ON state by the locker management unit 4001. In addition, the display control unit 4002 specifies the locker ID of the locker 12 in which the commodity was stored (delivered) based on the locker ID notified from the control device 13 (reception notification unit 1304) or the locker ID for which the delivery flag is switched to the ON state. Next, the display control unit 4002 reads a store image and a commodity image corresponding to the specified store ID and commodity ID from the store image management table T2 and the commodity image management table T3. Then, the display control unit 4002 transmits one or both of the read shop image and commodity image to the control device together with the display method that specifies the specified locker ID.

When the display control unit 1305 of the control device 13 acquires the image and the display method (locker ID) from the server device 40 (display control unit 4002), the display control unit 1305 displays the acquired image on the display unit 122 of the locker 12 corresponding to the specified locker ID. By the cooperative operation described above, the display unit 122 of the locker 12 in which the commodity was stored displays a commodity image indicating the type of the commodity and a store image of a store that manufactures and sells the commodity.

FIG. 10 is a diagram showing an example of an image displayed on the storage device 10. FIG. 10 shows an example in which a commodity image G1 indicating the type of the commodity is displayed as an image related to the commodity stored in the locker 12. In FIG. 10, for simplification of description, the commodity images G1 of the commodities related to the same store are represented by the same appearance (circle, square, and triangle) (the same applies to FIGS. 11 to 14).

As shown in FIG. 10, the commodity image G1 of each commodity is displayed on the locker 12 in which the commodity is stored. With this display, the user who ordered the commodity (hereinafter, also referred to as an order user) looks at the front side of the storage device 10 and an approximate position of the locker 12 storing the commodity ordered by the user can be grasped based on the type and appearance of the commodity image G1.

In addition, by looking at the front side of the storage device 10, users other than the order user can check the popular commodities and the order status of the commodities at each store from the type and the appearance of the commodity image G1. As described above, in the storage device 10, since the commodity image G1 displayed on the display unit 122 can be used as digital signage, advertisement of store and promotion of purchase motivation for users other than the order user can be achieved.

FIG. 11 is a diagram showing another example of a screen displayed on the storage device 10. FIG. 11 shows an example in which a store image G2 related to a store that manufactures and sells the commodity is displayed as an image of the product stored in the locker 12.

As shown in FIG. 11, the store image G2 of the store related to the commodity is displayed on the locker 12 in which the commodity is stored. With this display, the order user can grasp the approximate position of the locker 12 in which the commodity ordered by the user is stored from the contents and the appearance of the store image G2 by looking at the front side of the storage device 10.

In addition, by looking at the front side of the storage device 10, users other than the order user can intuitively confirm the popular store from the number of display of the store image G2 of each store and the ratio of the store image G2 to the entire screen. As described above, in the storage device 10, since the store image G2 displayed on the display unit 122 can be used as digital signage, advertisement of store and promotion of purchase motivation for users other than the order user can be achieved.

When both the commodity image G1 and the store image G2 are provided to the control device 13, the control device 13 may display any of the images. In addition, the control device 13 instructed by the display control unit 4002 to perform a display method of switching and displaying both images is to switch and display the commodity image G1 and the store image G2 at predetermined time intervals.

The display method that can be specified by the display control unit 4002 is not limited to the above example. For example, when there are a plurality of lockers 12 that store commodities related to the same store ID, the display control unit 4002 may instruct a display method of displaying a single store image G2 using the display unit 122 of the locker 12.

Further, for example, when the arrangement positions of the lockers 12 that store the commodities related to the same store ID form a cluster, the display control unit 4002 may instruct a display method of displaying a single store image G2 using the display unit 122 of each locker 12 that forms the cluster.

In this case, the display control unit 4002 transmits the display method including the single store image G2 to be displayed, the locker ID of each locker 12 forming the cluster, and the instruction information for instructing an enlarged display to the control device 13. When store images G2 having different display sizes are stored in the store image management table T2, the display control unit 4002 may select a store image G2 having a larger display size as a display target.

On the other hand, when the display control unit 4002 instructs an enlarged display as a display method, the display control unit 1305 of the control device 13 displays the store image G2 to be displayed on the display unit 122 of the locker 12 corresponding to each of the specified locker IDs. As a result, the store image G2 is enlarged and displayed on the display unit 122 of the lockers 12 forming the cluster, as shown in FIG. 12.

FIG. 12 is a diagram showing an example of an image displayed on the storage device 10. FIG. 12 shows a display example when an enlarged display is instructed as a display method. Here, an example is shown in which one store image G2 is displayed on the display unit 122 of the locker 12 (the locker 12 that displays a square image) forming the clusters shown in FIGS. 10 and 11.

As shown in FIG. 12, when the enlarged display is specified as the display method, the store image G2 representing the store is enlarged and displayed on the display unit 122 of each locker 12 forming the cluster in which the commodities of the same store (store ID) are stored. With this display, by looking at the front side of the storage device 10, the order user can grasp the approximate position of the locker 12 in which the commodity ordered by the user is stored from the position where the store image G2 is displayed.

In addition, by looking at the front side of the storage device 10, users other than the order user can intuitively confirm a popular store from the size of the store image G2 of each store and the ratio of the store image G2 to the entire screen. As described above, in the storage device 10, since the store image G2 displayed on the display unit 122 can be used as digital signage, advertisement of store and promotion of purchase motivation for users other than the order user can be achieved.

When the enlarged display is performed, the minimum number of the lockers 12 to be displayed is two, but a condition may be set for the number of the lockers 12, the arrangement layout thereof, and the like. For example, a restriction condition may be set so that the enlarged display is performed when the number of lockers 12 constituting a cluster is equal to or greater than a threshold (for example, 5). Further, for example, a restriction condition may be set so that the enlarged display is performed when the arrangement layout of the lockers 12 constituting a cluster includes a 2×2 array (square array). By providing such a restriction condition, the visibility when the store image G2 is enlarged and displayed can be improved.

Further, when the terminal ID is notified from the control device 13, the display control unit 4002 cooperates with the locker management unit 4001 to specify the locker ID corresponding to the terminal ID from the locker management table T1. Then, the display control unit 4002 instructs the control device 13 to indicate the specified locker ID.

When the indication of the specific locker ID is instructed from the server device 40 (display control unit 4002), the display control unit 1305 of the control device 13 highlights the image displayed on the locker 12 of the display unit 122 corresponding to the instructed locker ID as shown in FIG. 13.

FIG. 13 is a diagram showing an example of an image displayed on the storage device 10. FIG. 13 shows an example in which the screen (commodity image G1) of the locker 12 positioned on the second from the top and the fourth from the left of the storage device 10 is highlighted. FIG. 13 shows an example in which a frame G3 is displayed at the edge of the screen to highlight the image.

By the above-described processing, when the user inputs the terminal ID via the short-range communication unit 131, the control device 13 indicates the locker 12 that stores the commodity ordered by the user by highlighting the screen. Thereby, the order user can easily confirm the locker 12 in which the commodity ordered by the user is stored. Therefore, the storage device 10 can improve the convenience of receiving the commodity.

In FIG. 13, the locker 12 for storing the commodity ordered by the user is indicated by highlighting the screen, but the locker 12 may be indicated by another method. For example, a light emitting device such as a light emitting diode (LED) may be provided at the edge of the door unit 121 of the locker 12 and the light emitting device emits light, thereby indicating the corresponding locker 12.

Further, the display control unit 4002 detects the locker ID of the locker 12 in which the reception of the commodity was performed, based on a notification from the control device 13 or a process of clearing the locker management table T1 by the locker management unit 4001. When detecting the locker ID of the locker 12 in which the reception of the commodity was performed, the display control unit 4002 transmits a display termination instruction with the locker ID specified to the control device 13.

When the display termination is instructed from the server device 40, the electronic lock control unit 1302 of the control device 13 ends the display of the image by clearing the image displayed on the display unit 122 of the locker 12 corresponding to the specified locker ID, and the like.

As described above, in the locker system 1, the image displayed on the display unit 122 of the locker 12 is changed according to the commodity stored in the locker 12 by the cooperation of the display control unit 1305 of the control device 13 and the display control unit 4002 of the server device 40. As a result, an image corresponding to the commodity is displayed on the display unit 122 of each locker 12 while the commodity is stored in the locker 12.

In the present embodiment, among the locker IDs registered in the locker management table T1, the locker ID of the empty locker is excluded from the display target of the image, but the present disclosure is not limited to this mode.

For example, when the locker ID of the empty locker is present in the locker management table T1, the display control unit 4002 may transmit an advertisement image for advertising a facility or a food court to the control device 13 together with the corresponding locker ID. When the empty lockers form a cluster, the display control unit 4002 may specify the display method of the enlarged display together with the locker ID of each locker 12 that forms the cluster in the same manner as described above. On the other hand, the display control unit 1305 of the control device 13 displays the advertisement image acquired from the server device 40 on the display unit 122 of the locker 12 corresponding to the specified locker ID, that is, the display unit 122 of the empty locker. With this configuration, it is possible to effectively use the display unit 122 of the empty locker to advertise a food court or the like, so that it is possible to promote the purchase motivation of users and to promote sales at each store.

Further, in FIGS. 10 to 13, the example in which the commodity image G1 or the store image G2 is displayed on the display unit 122 of the locker 12 is described, but the present disclosure is not limited thereto, and another image may be displayed. For example, as shown in FIG. 14, a locker ID image G4 indicating the locker ID of the locker 12 may be displayed on the display unit 122 of each locker 12. Here, FIG. 14 is a diagram showing an example of an image displayed on the storage device 10.

For example, depending on the operation mode of a food court or a store, when a user places an order for a commodity, the store or the server device 40 notifies the user terminal 30 of a locker ID to receive the commodity. In such a case, by displaying the locker ID image G4 on the display unit 122 of each locker 12, the user can easily determine the locker 12 in which the commodity ordered by the user is stored.

The locker ID image G4 may be displayed by cooperation of the display control unit 4002 and the display control unit 1305, or may be displayed by display control of the display control unit 1305 alone. Further, the locker ID image G4 may be displayed at all times, or may be controlled to be displayed temporarily. In the latter case, for example, the display of the locker ID image G4 is started at the timing when the terminal ID acquisition unit 1301 acquires the terminal ID, and the locker ID image G4 is displayed for a predetermined time (until the reception of the commodity is completed as an example).

Hereinafter, an operation example of the locker system 1 described above will be described.

First, operations performed by the store server 20, the user terminal 30, and the server device 40 when ordering a commodity will be described with reference to FIG. 15. Here, FIG. 15 is a sequence diagram showing an example of processing performed by the store server 20, the user terminal 30, and the server device 40.

First, the user terminal 30 transmits order information including the commodity ID to be ordered to the store server 20 together with the terminal ID of the user terminal 30 (ACT 11). Upon receiving the order information and the terminal ID from the user terminal 30, the store server 20 transmits the store ID of its own store to the server device 40 together with the information (ACT 12).

Upon receiving various information such as order information from the store server 20, the locker management unit 4001 of the server device 40 refers to the locker management table T1 and searches for a locker ID of an empty locker (ACT 13). Next, the locker management unit 4001 registers various information received from the store server 20 in association with the searched locker ID of the empty locker (ACT 14). Then, the locker management unit 4001 notifies the store server 20 of the registered locker ID as a commodity storage (delivery) destination (ACT 15).

Upon receiving the locker ID notification from the server device 40, the store server 20 sends an order completion notification to the user terminal 30 indicating that the order reception was completed (ACT 16). Here, the store server 20 may transmit the order completion notification including the locker ID notified from the server device 40.

The method of payment for the commodity ordered by the user is not particularly limited. For example, the user may pay for the commodity by electronic payment by operating the user terminal 30.

Next, operations performed by the storage device 10 (control device 13) and the server device 40 when a commodity is delivered will be described with reference to FIG. 16. Here, FIG. 16 is a sequence diagram showing an example of processing performed by the control device 13 and the server device 40.

First, when the delivery notification unit 1303 of the control device 13 detects that a commodity is stored (delivered) in the locker 12 by opening and closing the door unit 123 (ACT 21), the delivery notification unit 1303 of the control device 13 notifies the server device 40 of the locker ID of the locker 12 of the detection source together with information indicating the storage detection (ACT 22).

When the locker management unit 4001 of the server device 40 is notified of the locker ID of the locker 12 in which the commodity is stored, from the control device 13, the locker management unit 4001 sets the delivery flag of the locker management table T1 corresponding to the locker ID to ON (ACT 23). Subsequently, the display control unit 4002 performs display image determination processing that determines an image to be displayed on the display unit 122 of the locker 12 corresponding to the locker ID based on various information related to the locker ID of the locker 12 in which the commodity is stored (ACT 24). The display image determination processing will be described later (see FIG. 17).

Then, the display control unit 4002 of the server device 40 transmits the image read in the display image determination processing and the display method including the locker ID of the locker 12 in which the commodity is stored to the control device 13 (ACT 25).

When the image and the display method are acquired from the server device 40, the display control unit 1305 of the control device 13 causes the display unit 122 of the locker 12 to display the acquired image based on the instructed display method (ACT 26).

Next, the above-described display image determination processing will be described with reference to FIG. 17. Here, FIG. 17 is a flowchart showing an example of the display image determination processing performed by the server device 40.

First, the display control unit 4002 refers to the locker management table T1 and specifies the locker ID notified from the control device 13, that is, the store ID and the commodity ID associated with the locker ID of the locker 12 in which the commodity is stored (ACT 31).

Subsequently, the display control unit 4002 reads images (the store image and the commodity image) corresponding to the store ID and the commodity ID specified in ACT 31 from the store image management table T2 and the commodity image management table T3 (ACT 32).

Subsequently, the display control unit 4002 specifies the arrangement position on the storage device 10 of each locker 12 corresponding to the locker ID in which the same store ID as the store ID specified in ACT 31 is registered (ACT 33). Next, the display control unit 4002 determines whether each locker 12 forms a cluster based on the process result of ACT 33 (ACT 34). Here, when it is determined that a cluster is to be formed (ACT 34; Yes), the display control unit 4002 proceeds to ACT 35.

In ACT 35, the display control unit 4002 determines whether or not the number of lockers 12 constituting the cluster is equal to or greater than a threshold (for example, 5 or more). If the number is less than the threshold (ACT 35; No), the process proceeds to ACT 37. If the number of the lockers 12 constituting the cluster is equal to or greater than the threshold (ACT 35; Yes), the process proceeds to ACT 36.

In ACT 36, the display control unit 4002 transmits the store image acquired in ACT 32 and the display method (enlarged display) in which the locker ID of the lockers 12 constituting the cluster is specified to the control device 13 (ACT 36). The process in ACT 36 corresponds to ACT 25 in FIG. 16.

On the other hand, if it is determined in ACT 34 that a cluster is not formed (ACT 34; No), the display control unit 4002 proceeds to ACT 37. In ACT 37, the display control unit 4002 transmits the display method that instructs the locker ID notified from the control device 13 to alternately display the store image and the commodity image read in ACT 32 to the control device 13 (ACT 37). The process in ACT 37 corresponds to ACT 25 in FIG. 16.

By the above processing, an image (the store image or the commodity image) corresponding to the stored commodity is displayed on the display unit 122 of the locker 12 in which the commodity is stored.

Next, an operation performed by the storage device 10 (control device 13) and the server device 40 when a commodity is received will be described with reference to FIG. 18. Here, FIG. 18 is a sequence diagram showing an example of processing performed by the control device 13 and the server device 40.

First, the terminal ID acquisition unit 1301 of the control device 13 acquires the terminal ID from the user terminal 30 via the short-range communication unit 131 (ACT 41). The terminal ID acquisition unit 1301 transmits the terminal ID acquired from the user terminal 30 to the server device 40 (ACT 42).

When receiving the terminal ID from the control device 13, the locker management unit 4001 of the server device 40 specifies the locker ID corresponding to the terminal ID from the locker management table T1 (ACT 43). Next, the display control unit 4002 of the server device 40 instructs the control device 13 to indicate the locker ID specified in ACT 43 (ACT 44).

When the locker ID is instructed from the server device 40, the display control unit 1305 of the control device 13 highlights the screen displayed on the display unit 122 of the locker 12 corresponding to the instructed locker ID to indicate the locker 12 (ACT 45). The electronic lock control unit 1302 of the control device 13 releases (unlocks) the electronic lock provided in the door unit 121 of the corresponding locker 12 based on the locker ID instructed in ACT 44 or the locker ID instructed by the locker management unit 4001 of the server device 40 (ACT 46). This allows the user to receive (take out) the commodity ordered by the user from the locker 12 in which the commodity is stored.

Subsequently, when the reception notification unit 1304 of the control device 13 detects that the commodity was taken out of the locker 12 by the opening and closing operation of the door unit 121 (ACT 47), the reception notification unit 1304 notifies the server device 40 of the locker ID of the locker 12 of the detection source together with the information indicating the completion of the reception (ACT 48).

When the locker management unit 4001 of the server device 40 is notified of the locker ID of the locker 12 in which the reception of the commodity was completed from the control device 13, the locker management unit 4001 clears various information associated with the locker ID from the locker management table T1 (ACT 49). Subsequently, the display control unit 4002 transmits an instruction to end the display of the locker ID that became an empty locker by clearing various information, to the control device 13 (ACT 50).

When the display termination is instructed from the server device 40, the display control unit 1305 of the control device 13 stops displaying the locker 12 corresponding to the specified locker ID, thereby terminating the display of the commodity image G1 or the store image G2 (ACT 51).

As described above, when a commodity is stored in the locker 12, the storage device 10 of the present embodiment acquires an image corresponding to the commodity from the server device 40 and displays the image on the display unit 122 of the locker 12. Thereby, the storage device 10 can present information related to the commodity stored in each locker 12 to the user who waits for receiving the commodity. Therefore, the storage device 10 can provide a screen (digital signage) that allows a user who waits for receiving the commodity near the storage device to easily check the storage status of the commodity, thereby improving the convenient. [0141]In addition, the storage device 10 of the present embodiment causes the display unit 122 of the locker 12 to display a commodity image representing a commodity stored in the locker 12 or a store image representing a store that manufactures and sells the commodity. Accordingly, the storage device 10 allows the user who waits for receiving the commodity to know the approximate position of the locker 12 in which the commodity ordered by the user is stored, thereby improving the convenience.

In addition, when there are a plurality of lockers 12 that store commodities sold in the same store, the storage device 10 of the present embodiment uses the display unit 122 provided in the locker 12 to display one store image representing the store. Thereby, the storage device 10 can display the store image related to the stored commodity on the plurality of display units 122.

In addition, when the lockers 12 that store commodities sold in the same store form a cluster, the storage device 10 of the present embodiment uses the display unit 122 provided in the lockers 12 that form the cluster to display one store image representing the store. Thereby, the storage device 10 can enlarge and display the store image related to the stored commodity.

The above-described embodiment can be appropriately modified and implemented by partially changing the configuration or function of each device described above. Therefore, hereinafter, some modifications according to the above-described embodiment will be described as another embodiment. In the following, points different from the above-described embodiment will be mainly described, and detailed description of points common to the already described contents will be omitted. Further, the modifications described below may be implemented individually or may be implemented in combination as appropriate.

### Modification 1

In the above-described embodiment, the use status of the storage device 10 is managed by the server device 40. However, the present disclosure is not limited thereto, and the control device 13 may manage the use status.

In this case, the control device 13 includes, for example, the locker management table T1 of the server device 40 and the functions of the locker management unit 4001 and the display control unit 4002 in addition to the above-described configuration. With such a configuration, the cooperative operation between the control device 13 and the server device 40 in the above-described embodiment can be realized by the storage device 10 (control device 13) alone.

The control device 13 maybe configured to hold the store image management table T2 and the commodity image management table T3, or may be configured to refer to the store image management table T2 and the commodity image management table T3 stored in another server device.

### Modification 2

In the above-described embodiment, the case where the commodities of one store are stored in one locker 12 is described. However, the present disclosure is not limited thereto, and the commodities of a plurality of stores may be stored in one locker 12.

In this case, the display control unit 4002 reads, from the store image management table T2, a store image related to a store that manufactures and sells each commodity stored in the locker 12. Then, the display control unit 4002 transmits the locker ID of the corresponding locker 12 and the display method instructing the switching display of the store images to the control device 13. In addition, the display control unit 1305 causes the display unit 122 of the locker 12 corresponding to the specified locker ID to switch and display a plurality of store images related to each commodity stored in the locker 12 at predetermined time intervals.

As a result, even when a plurality of commodities related to a plurality of stores are stored in the same locker 12, the storage device 10 can display the store images representing these stores on the display unit 122 of the locker 12.

### Modification 3

In the above embodiment, the openings (12a and 12b) and the door units (121 and 123) are provided on the front side and the back side of the locker 12. However, the present disclosure is not limited thereto, and the opening and the door unit may be provided only on the front side of the locker 12. In this case, the opening 12a provided on the front surface of the locker 12 is used when delivering and receiving the commodity.

When this modification is adopted, the display unit 132 and the input unit 133 of the control device 13 are preferably arranged on the front side of the housing 13a. Further, in response to an operation via the input unit 133, the electronic lock control unit 1302 of the control device 13 unlocks the electronic lock of the locker ID specified by the operation. For example, when receiving an input of a store ID, a preset password, and the like together with the locker ID via the input unit 133, the electronic lock control unit 1302 unlocks the electronic lock provided on the door unit 121 of the locker 12 corresponding to the locker ID. In addition, the electronic lock control unit 1302 may receive an input of a store ID, a password, or the like via the short-range communication unit 131.

When this modification is adopted, the delivery notification unit 1303 and the reception notification unit 1304 are integrated, and the locker ID corresponding to the locker 12 on which the door unit 121 was opened may be transmitted to the server device 40. In this case, the server device 40 updates the delivery flag of the locker management table T1 according to the locker ID transmitted from the control device 13, so that the server device 40 side can manage whether or not the commodity was delivered to the locker 12.

Specifically, when the delivery flag of the locker ID transmitted from the control device 13 is OFF, the locker management unit 4001 sets the delivery flag to ON so that the commodity becomes in the delivered state. In addition, when the delivery flag of the locker ID transmitted from the control device 13 is ON, the locker management unit 4001 sets (resets) the delivery flag to OFF so that the commodity becomes in the state of completion of reception. When resetting the delivery flag, the locker management unit 4001 clears information such as a store ID and a commodity ID associated with the locker ID corresponding to the delivery flag.

Thus, the storage device 10 of the present modification can provide the same effects as those of the above-described embodiment even when the opening 12a and the door unit 121 are provided only on the front side of the locker 12.

### Modification 4

In the above embodiment, the case where the storage device 10 is used in the food court is described, but the usage of the storage device 10 is not limited thereto. For example, the storage device 10 may be applied to an environment other than a food court, or may store commodities other than food.

The program executed by each device of the above-described embodiment is provided by being incorporated in a ROM or the like in advance. The program executed by each device of the above-described embodiment may be provided by recording a file in an installable format or an executable format in a computer readable recording medium such as a CD-ROM, a flexible disk (FD), a CD-R, and a Digital Versatile Disk (DVD).

Furthermore, the program executed by each device of the above-described embodiments may be stored on a computer connected to a network such as the Internet, and provided by allowing to be downloaded via the network. Further, the program executed by each device of the above-described embodiment may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device, comprising:
a storage space for storing commodities therein and provided with a first opening accessible to the storage space;
a first door capable of opening and closing the first opening;
a display provided on a surface of the first door; and
a controller configured to acquire an image corresponding to a commodity and display the image on the display when the commodity is stored in the storage space.

2. The device according to claim 1, wherein
the controller causes the display to display an image representing a type of a commodity stored in the storage space or an image representing a store selling the commodity stored in the storage space.

3. The device according to claim 2, wherein
a plurality of storage spaces are provided and arranged in at least one of a horizontal direction and a height direction, and
the controller displays one image representing the store using the display provided in the storage space when there are a plurality of storage spaces that store commodities sold in the same store.

4. The device according to claim 3, wherein
when the plurality of storage spaces that store commodities sold in the same store form a cluster, the controller displays one image representing the store using the displays provided in the storage spaces forming the cluster.

5. The device according to claim 1, wherein
the storage space includes a second opening accessible to the storage space on a side facing the first opening,
the device further comprising:
a second door capable of opening and closing the second opening.

6. The device according to claim 1, wherein
the commodities comprise food items.

7. The device according to claim 1, wherein
the commodities comprise beverage items.

8. A method causing a computer of a storage device including a storage space for storing commodities therein and provided with a first opening on a front surface accessible to the storage space, a first door capable of opening and closing the first opening, and a display provided on a surface of the first door,
displaying an image corresponding to a commodity on the display when the commodity is stored in the storage space.

9. The method according to claim 8, further comprising:
displaying an image representing a type of a commodity stored in the storage space or an image representing a store selling the commodity stored in the storage space.

10. The method according to claim 9, wherein
a plurality of storage spaces are provided and arranged in at least one of a horizontal direction and a height direction,
further comprising:
displaying one image representing the store using the display provided in the storage space when there are a plurality of storage spaces that store commodities sold in the same store .

11. The method according to claim 10, wherein
when the plurality of storage spaces that store commodities sold in the same store form a cluster,
further comprising:
displaying one image representing the store using the displays provided in the storage spaces forming the cluster.

12. The method according to claim 8, wherein
the storage space includes a second opening accessible to the storage space on a side facing the first opening,
the device further comprising:
a second door capable of opening and closing the second opening.

13. The method according to claim 8, wherein
the commodities comprise food items.

14. A food storage system, comprising:
a plurality of storage spaces each for storing a food commodity therein and each provided with a first opening accessible to a corresponding storage space;
a plurality of first doors each capable of opening and closing a corresponding first opening;
a display; and
a controller configured to acquire an image corresponding to a specific food commodity and display the image on the display when the specific food commodity is stored in at least one of the storage spaces.

15. The food storage system according to claim 14, wherein
the controller causes the display to display an image representing a type of the food commodity stored in at least one of the storage spaces or an image representing a store selling the food commodity stored in at least one of the storage spaces.

16. The food storage system according to claim 14, wherein
the plurality of storage spaces are arranged in at least one of a horizontal direction and a height direction, and
the controller displays one image representing the store using the display.

17. The food storage system according to claim 16, wherein
when the plurality of storage spaces that store commodities sold in the same store form a cluster, the controller displays one image representing the store using the displays forming the cluster.

18. The food storage system according to claim 14, wherein
the storage spaces include a second opening accessible to the storage spaces on a side facing the first opening and a second door capable of opening and closing the second opening.

19. The food storage system according to claim 14, wherein
the food commodity comprises one of a plurality of food items.

20. The food storage system according to claim 14, wherein
the food commodity comprises one of a plurality of beverage items.
